(19) United States
(12) Patent Application Publication
(10) Pub. No.: US 2014/0001294 A1
(43) Pub. Date: Jan. 2, 2014

(54) STIRRED MILL, METHOD OF SIMULATING A GRINDING PROCESS IN A STIRRED MILL, AND METHOD OF GRINDING A MATERIAL IN A STIRRED MILL

(71) Applicant: Jonathan Charles Allen, York, PA (US)

(72) Inventor: Jonathan Charles Allen, York, PA (US)

(73) Assignee: METSO MINERALS INDUSTRIES, INC., Waukesha, WI (US)

(21) Appl. No.: 13/537,419

(22) Filed: Jun. 29, 2012

(51) Int. Cl. B02C 17/16; B02C 23/00

(52) U.S. Cl. 241/27; 241/98

(57) ABSTRACT

A stirred mill comprises a container for containing grinding media and a material to be ground. The container has a longitudinal axis, and an agitator arranged in said container along said longitudinal axis. A restrictor plate is arranged in said container, extending across said longitudinal axis, and arranged to be positioned on top of the grinding media. A method of simulating a grinding process of a stirred mill of a first height in a stirred mill of a second height is also disclosed, wherein said second height is less than said first height. Further, a method of grinding material in a stirred mill is disclosed.

### FIELD OF THE INVENTION

The present invention relates to stirred mill comprising a container for containing grinding media and a material to be ground, said container having a longitudinal axis, and an agitator arranged in said container along said longitudinal axis. The present invention further relates to a method of simulating a grinding process of a stirred mill of a first height in a stirred mill of a second height, said second height being less than said first height, and to a method of grinding a material in a stirred mill.

### BACKGROUND

Stirred mills are known, e.g., from U.S. Pat. No. 4,174,074 and from the brochure “VERTIMILL™-Fine and ultrafine wet grinding”, having a container in which an agitator is arranged. Grinding media, such as steel balls or ceramic or natural pebbles, is provided in the container. Water and the material to be ground is fed into the container. By rotating the agitator, the charge is agitated, such that the grinding media grinds the material to be ground by abrasion and attrition. The two references mentioned above disclose vertically arranged stirred mills. However, the same general principle is used in horizontally arranged stirred mills.

While these known stirred mills perform satisfactorily, there are at least two reasons why it would be beneficial to use smaller stirred mills. One is that, the known stirred mills are generally very large and cumbersome, thereby not always being easy to fit in an existing plant. Another reason is that, when studying the processes acting in a stirred mill, it is difficult and expensive to set up a full scale stirred mill for laboratory or experimental use. Hence, a need exists for a smaller stirred mill, which may give grinding results corresponding to those of a larger stirred mill.

### SUMMARY

An object of the invention is to provide a stirred mill, which requires less space, but which makes it possible to get grinding results equivalent to those of existing stirred mills.

Another object of the invention is to provide a stirred mill, which is useful in a laboratory environment.

Yet another object of the invention is to provide a method of simulating a grinding process of a larger stirred mill in a smaller stirred mill.

A further object of the invention is to provide a method of grinding a material in a stirred mill, which enables grinding results equivalent to those of a larger stirred mill in a smaller stirred mill.

According to a first aspect of the invention, these and other objects are achieved, in full or at least in part, by a stirred mill comprising a container for containing grinding media and a material to be ground, said container having a longitudinal axis, and an agitator arranged in said container along said longitudinal axis, a restrictor plate being arranged in said container, extending across said longitudinal axis, and arranged to be positioned on top of the grinding media. With such a stirred mill, it is possible to exert an additional pressure on the grinding media, using the restrictor plate. Thereby, the grinding process may be influenced. For instance, results corresponding to those achievable in a larger stirred mill may be achieved in a smaller stirred mill. As used herein, “on top of the grinding media” is to be construed broadly, and not only as vertically above the grinding media. If the container is vertically arranged, the restrictor plate will be arranged vertically above the grinding media. If, on the other hand, the container is horizontally arranged, the restrictor plate will be arranged to the right or to the left of the grinding media, depending on the viewing direction. Generally, “on top of the grinding media” means that the restrictor plate is arranged at the free surface of the grinding media, i.e. at the surface not in contact with an end wall of the container. Thus, in a vertical stirred mill, the grinding media will be confined between the bottom of the container and the restrictor plate, whereas in a horizontal stirred mill, the grinding media will be confined between one of the end walls of the container and the restrictor plate. Analogously, if the container is oriented in an angled direction, between horizontal and vertical, the grinding media will be confined between an end wall of the container and the restrictor plate.

According to an embodiment, the restrictor plate extends essentially across an entire cross section of said container. In this manner, a uniform pressure may more easily be exerted on the grinding media.

According to another embodiment, the restrictor plate extends generally perpendicular to said longitudinal axis. Such a perpendicular arrangement is mechanically simple to realize.

The longitudinal axis may be a vertical axis, i.e. the container may be arranged vertically. In a vertically arranged stirred mill, the restrictor plate makes it possible to simulate the grinding process of a taller stirred mill in a smaller stirred mill by exerting a pressure on the grinding media, which corresponds to an additional pressure that would have been exerted by overlying grinding media and material to be ground, had the stirred mill been taller.

Apertures may be formed in the restrictor plate. The apertures allow water and foam to pass through the restrictor plate.

According to an embodiment, the stirred mill further comprises a suspension device by means of which said restrictor plate is held in the container so as to be positioned on top of the grinding media. Thereby, the restrictor plate need not rest on the grinding media, and a position of the restrictor plate in the container may be fixed as desired.

The suspension device may comprise height adjustment means arranged to adjust a height of said restrictor plate along said vertical axis. In this manner, the position of the restrictor plate may be chosen depending on the amount of grinding media present in the container, but also depending on which pressure it is desirable to exert on the grinding media.

The suspension device may comprise at least one threaded rod extending through a hole in said restrictor plate, and at least one nut threaded onto said threaded rod, positioning said restrictor plate on said threaded bar. This is a mechanically simple way of realizing a height adjustment of the restrictor plate.

The suspension device may comprise a hydraulic control, thereby allowing automation of the height adjustment of the restrictor plate.

In an embodiment, the container has the shape of a circular cylinder. With a circular cylindrical container, the agitator may be particularly simply mounted in the container, since a bearing at the non-driven end of the agitator may be dispensed with if the shape of the container restricts the movement of the agitator.

According to a second aspect of the invention, these and other objects are achieved, in full or at least in part, by a method of simulating a grinding process of a stirred mill of a first height in a stirred mill of a second height, said second height being less than said first height, said method comprising the steps of:

providing a stirred mill of a second height, said stirred mill comprising a container having a vertical axis, and an agitator arranged in said container along said vertical axis,

providing grinding media in said container,

feeding material to be ground into said container,

arranging a restrictor plate on top of the grinding media, across said vertical axis,

exerting a pressure on said grinding media by means of said restrictor plate, said pressure corresponding to an additional pressure that would be exerted by overlying grinding media and material to be ground in a stirred mill of the first height, and

rotating said agitator, thereby grinding the material to be ground. The use of a restrictor plate makes it possible to exert a pressure on the grinding media, such that the pressure present in a taller stirred mill may be provided in a smaller stirred mill. This is useful particularly when making experimental studies on a stirred mill, since it may make it possible to use a smaller stirred mill, and yet study a grinding process that is equivalent to one in a taller stirred mill.

In a variant of the method, the restrictor plate is arranged essentially perpendicularly to said vertical axis. This is a mechanically simple structure.

The container may have the shape of a circular cylinder. This enables a particularly simple mounting of the agitator in the container, since a bearing at the non-driven end of the agitator may be dispensed with if the shape of the container restricts the movement of the agitator.

According to a third aspect of the invention, these and other objects are achieved, in full or at least in part, by a method of grinding a material in a stirred mill, comprising the steps of:

providing a stirred mill comprising a container having a longitudinal axis, and an agitator arranged in said container along said longitudinal axis,

providing grinding media in said container,

feeding the material to be ground into said container,

arranging a restrictor plate on top of the grinding media, across said longitudinal axis,

exerting a pressure on said grinding media by means of said restrictor plate, and

rotating said agitator, thereby grinding the material to be ground. The use of a restrictor plate makes it possible to exert a desired pressure on the grinding media. Thereby, grinding results corresponding to those of a larger stirred mill may be achieved in a smaller stirred mill.

The restrictor plate may be arranged essentially perpendicularly to said longitudinal axis, thereby making the structure particularly simple.

In a variant of the method, the container is arranged vertically, such that said longitudinal axis is a vertical axis. In a vertically arranged stirred mill, the restrictor plate makes it possible to simulate the grinding process of a taller stirred mill in a smaller stirred mill by exerting a pressure on the grinding media, which corresponds to an additional pressure that would have been exerted by overlying grinding media and material to be ground, had the stirred mill been taller.

According to a variant, the container has the shape of a circular cylinder. This enables a particularly simple mounting of the agitator in the container, since a bearing at the non-driven end of the agitator may be dispensed with if the shape of the container restricts the movement of the agitator.

Other objectives, features and advantages of the present invention will appear from the following detailed disclosure, from the attached claims, as well as from the drawings. It is noted that the invention relates to all possible combinations of features.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise. The steps of any method disclosed herein do not have to be performed in the exact order disclosed, unless explicitly stated.

As used herein, the term “comprising” and variations of that term are not intended to exclude other additives, components, integers or steps.

Various other features, objects and advantages of the invention will be made apparent from the following description taken together with the drawings.

### BRIEF DESCRIPTION OF THE DRAWINGS

The invention will be described in more detail with reference to the appended schematic drawings, which show an example of a presently preferred embodiment of the invention:

FIG. 1 is a perspective view of a stirred mill according to an embodiment; and

FIG. 2 is a cross-sectional view of the stirred mill of FIG. 1.

### DETAILED DESCRIPTION

The present invention will now be described more fully hereinafter with reference to the accompanying drawings, in which currently preferred embodiments of the invention are shown. The present invention may, however, be embodied in many different forms and should not be construed as limited to the embodiments set forth herein; rather, these embodiments are provided for thoroughness and completeness, and to fully convey the scope of the invention to the skilled addressee. Like reference characters refer to like elements throughout.

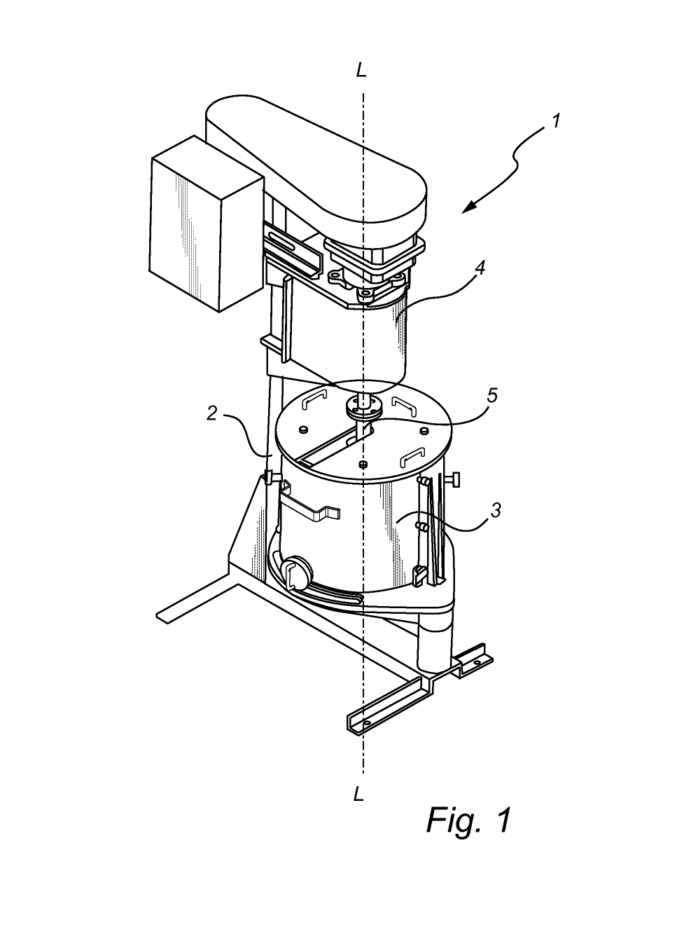

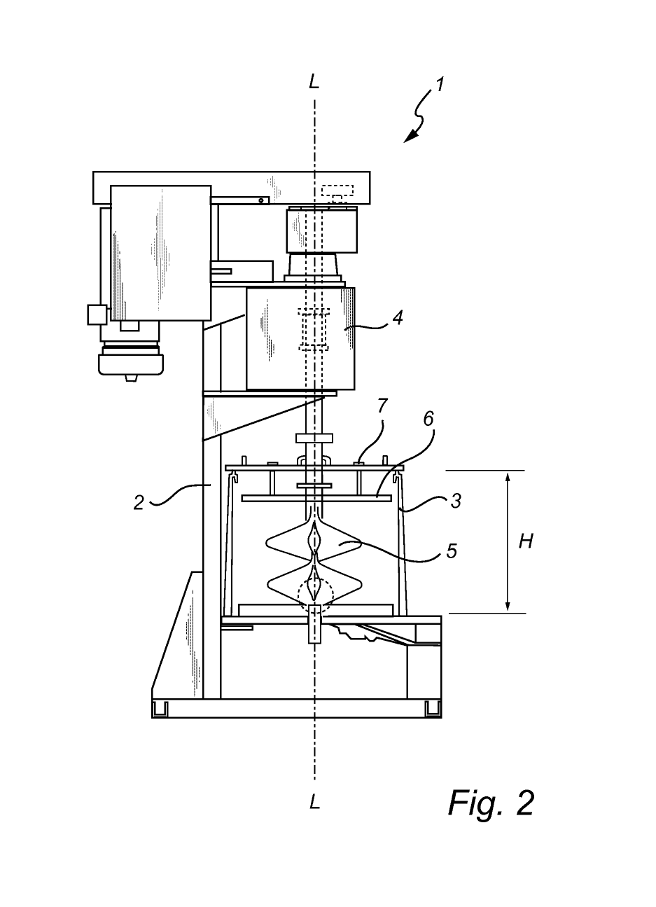

FIG. 1 shows a stirred mill 1 according to an embodiment. The stirred mill 1 has a frame 2 on which a container 3 and a drive arrangement 4 are mounted. The drive arrangement includes a motor and a transmission, which are known per se and will not be discussed further here. The stirred mill 1 has a longitudinal axis L, which in the embodiment shown is a vertical axis L. An agitator 5, which may be more clearly seen in FIG. 2, is arranged in the container 3, along the vertical axis L. The agitator 5 is here a helical screw, but may also have other designs such as pins or discs of different size and shape. In the container 3, in an upper portion, a restrictor plate 6 is arranged across the container 3. The restrictor plate 6 is suspended in the container 3 by a suspension device 7. In a simple form, useful, e.g., in a laboratory scale stirred mill, the suspension device may take the form of one or more threaded bars extending through a respective opening in the restrictor plate 6 and provided with a respective threaded nut for fixing a position of the restrictor plate 6 along the threaded bar. When grinding media in the form of, e.g., steel balls, and material to be ground, e.g. coal, have been introduced in the stirred mill 1, the restrictor plate 6 is intended to lie on top of the grinding media, thereby exerting a pressure on the grinding media. By choosing a suitable position of the restrictor plate along the vertical axis L, the pressure exerted by the restrictor plate on the grinding media may be controlled.

In the embodiment shown, the restrictor plate 6 extends essentially across an entire cross section of the container 3, and is arranged generally perpendicular to the vertical axis L. Apertures are formed in the restrictor plate 6, allowing water and foam to flow therethrough. Since the restrictor plate is intended to exert pressure on the grinding media, there is no need to make the restrictor plate impermeable to water.

The container 3 has the shape of circular cylinder. This makes it possible to dispense with a bearing at the lower end of the agitator 5, since the movement of the agitator 5 is restricted by the container 3.

If, e.g., for experimental reasons, the grinding process of a taller stirred mill is to be simulated in a smaller stirred mill, the following method may be used. A stirred mill 1 like the one shown in FIGS. 1 and 2 is provided, having a height H. Grinding media is provided in the container 3, and material to be ground is fed into the container 3. The restrictor plate 6 is arranged on top of the grinding media. The restrictor plate 6 exerts a pressure on the grinding media. By setting the position of the restrictor plate along the vertical axis L of the stirred mill 1, the pressure exerted may be controlled such that it corresponds to the additional pressure that would have been exerted by overlying grinding media and material to be ground, had the stirred mill 1 been taller, i.e. had the height H been higher.

Similarly, grinding may be conducted in the stirred mill 1 for other reasons than experimental reasons. The following method may be used. A stirred mill 1 is provided. Grinding media is provided in the container 3, and material to be ground is fed into the container 3. The restrictor plate 6 is arranged on top of the grinding media. The restrictor plate 6 exerts a pressure on the grinding media. By choosing the position of the restrictor plate 6 along the longitudinal axis L, the pressure exerted by the restrictor plate on the grinding media may be controlled. If the stirred mill is vertical, such as in the embodiment shown in FIGS. 1 and 2, grinding results of a taller stirred mill are achievable in a smaller stirred mill 1. If the stirred mill is horizontal, or arranged in any other direction, the restrictor plate may still be used to exert a pressure on the grinding media, thereby influencing the grinding process taking place in the stirred mill.

The skilled person realises that a number of modifications of the embodiments described herein are possible without departing from the scope of the invention, which is defined in the appended claims.

For instance, the grinding media need not be in the form of steel balls, but could be of another suitable material, such as a ceramic material, or of another shape, such as cylindrical, cubical or irregularly shaped.

The stirred mill and the methods of the invention are equally applicable when grinding materials other than coal, for instance ore.

The embodiment shown in the drawings is adapted for laboratory use. However, the principles described are equally valid for a full scale stirred mill.

In the drawings, a vertically arranged stirred mill is shown. However, the invention may also be applied to stirred mills oriented in other directions.

The container need not necessarily be a circular cylinder. Still, if another shape is chosen, the container may not be able to restrict the movement of the agitator, making a bearing at the non-driven end of the agitator necessary.

A restrictor plate without apertures may be used.

The restrictor plate could be made smaller, thereby not extending across an entire cross section of the container. Further, the restrictor plate need not necessarily be arranged perpendicular to the longitudinal axis of the stirred mill, but could in some cases be arranged at another angle to the longitudinal axis.

If automation of the adjustment of the position of the restrictor plate is desired, the suspension device may be provided with a hydraulic control or other, motorized, position adjustment means.

I claim:

1. A stirred mill comprising:
a container for containing grinding media and a material to be ground, said container having a longitudinal axis;
an agitator arranged in said container along said longitudinal axis; and
a restrictor plate arranged in said container, extending across said longitudinal axis and arranged to be positioned on top of the grinding media.

2. A stirred mill as claimed in claim 1, wherein said restrictor plate extends essentially across an entire cross section of said container.

3. A stirred mill as claimed in claim 1, wherein said restrictor plate extends generally perpendicular o said longitudinal axis.

4. A stirred mill as claimed in claim 3, wherein said longitudinal axis is a vertical axis.

5. A stirred mill as claimed in claim 3, wherein apertures are formed in said restrictor plate.

6. A stirred mill as claimed in claim 1, further comprising a suspension device by means of which said restrictor plate is held in the container so as to be positioned on top of the grinding media.

7. A stirred mill as claimed in claim 6, wherein said suspension device comprises height adjustment means arranged to adjust a height of said restrictor plate along said vertical axis.

8. A stirred mill as claimed in claim 6, wherein said suspension device comprises at least one threaded rod extending through a hole in said restrictor plate, and at least one nut threaded onto said threaded rod, positioning said restrictor plate on said threaded bar.

9. A stirred mill as claimed in claim 6, wherein said suspension device comprises a hydraulic control.

10. A stirred mill as claimed in claim 1, wherein the container has the shape of a circular cylinder.

11. A method of simulating a grinding process of a stirred mill of a first height in a stirred mill of a second height, said second height being less than said first height, said method comprising the steps of:
providing a stirred mill of a second height, said stirred mill comprising a container having a vertical axis and an agitator arranged in said container along said vertical axis;
providing grinding media in said container;
feeding material to be ground into said container;
arranging a restrictor plate on top of the grinding media, across said vertical axis;
exerting a pressure on said grinding media by means of said restrictor plate, said pressure corresponding to an additional pressure that would be exerted by overlying grinding media and material to be ground in a stifled mill of the first height; and
rotating said agitator, thereby grinding the material to be ground.

12. A method as claimed in claim 11, wherein said restrictor plate is arranged essentially perpendicularly to said vertical axis.

13. A method as claimed in claim 11, wherein said container has the shape of a circular cylinder.

14. A method of grinding a material in a stirred mill, comprising the steps of:
providing a stirred mill comprising a container having a longitudinal axis, and an agitator in said container along said longitudinal axis;
providing grinding media in said container;
feeding the material to be ground into said container;
arranging a restrictor plate on top of the grinding media, across said longitudinal axis;
exerting a pressure on said grinding media by means of said restrictor plate; and
rotating said agitator, thereby grinding the material to be ground.

15. A method as claimed in claim 14, wherein said restrictor plate is arranged essentially perpendicularly to said longitudinal axis.

16. A method as claimed in claim 14, wherein said container is arranged vertically, such that said longitudinal axis is a vertical axis.

17. A method as claimed in claim 14, wherein said container has the shape of a circular cylinder.
